(19) United States
(12) Patent Application Publication
(10) Pub. No.: US 2013/0191393 A1
(43) Pub. Date: Jul. 25, 2013

(54) EMOTIONAL MATCHING SYSTEM AND MATCHING METHOD FOR LINKING IDEAL MATES

(71) Applicant: Chang Hwan Ji, Seoul (KR)

(72) Inventor: Chang Hwan Ji, Seoul (KR)

(73) Assignee: BAROYEON CO., LTD, Seoul (KR)

(21) Appl. No.: 13/876,086

(22) PCT Filed: Sep. 29, 2011
(86) PCT No.: PCT/KR11/07180

§ 371 Date: Mar. 26, 2013

(30) Foreign Application Priority Data
Oct. 1, 2010 (KR) 10-2010-0095922

(51) Int. Cl. G06F 17/30

(52) U.S. Cl. CPC G06F 17/3053
USPC 707/737; 707/748

(57) ABSTRACT

The disclosure relates to an emotional matching system and a matching method for linking ideal mates by finding optimal ideal mates by identifying the level of attraction to the appearance of the other member and tendencies toward music, movies, and food through an emotional-based approach using brainwave changes.

### BACKGROUND OF THE INVENTION

1. Field of the Invention

The present invention relates to a matching system and a matching method for linking male members and female members for marriage and relationship, and particularly, an emotional matching system and a matching method for linking ideal mates by finding optimal ideal mates by identifying the level of attraction to the appearance of the other member and tendencies toward music, movies, and food through an emotional-based approach using brainwave changes.

2. Description of the Related Art

As marriage has become a business, profit-making companies a marriage counseling center under family rite rules, a matchmaking agency under commercial law, and a not-for-profit company a church (hereinafter called ‘marriage information company’) provide marriage information service targeting unmarried persons.

These marriage information companies have been trying to objectify, quantify the spouse market. It can be noted in the growth of internet-based matchmaking services. A method of online arranging and matchmaking for meeting or marriage is substantially as follows. It is needed to submit proof of identity requested by each company, and write a personal statement or information about ideal mate, when one becomes a member of a company. Separately, a marriage broker called a couple manager may collect additional personal information through direct consultation, depending on the company.

Based on the collected information, a company itself selects an appropriate partner for a member, and arranges a meeting between members. This arrangement process focuses on identification step of verifying a member's personal identification on paper, and step of systematic databasing various manual records written by members. This helps each company to analyze accuracy and objectivity of information for partners. Yet, most companies hire a plurality of marriage brokers called couple managers, and rely on their feeling and experience to analyze and verify information for partners and to reach a synthesized information-based final decision on the matching. Above this, there are cases using additive ways such as psychological test, marital compatibility test, blood type, four pillars and the eight characters and constellation.

Yet, the above ways do not have higher rates of marriage, success, post-matching maintenance period. The reason is that personal information presented by other members may be badness information and misinformation. For example, information for partners may be distorted during express hobby, preference, growth process, and describe ideal type, depending on users' convenience and subjectivity.

Even if personal information presented by other members is correct, it is unlikely that one can find and link real ideal mates with a present obsolete way of fixed appearance information such as body information, educational background, regional connection, job title of a member being absolute standard of matching.

This conventional method completely excludes emotional elements, the most important factor when considering ideal mates. Thus, it all comes down to problems in the end, like social cost caused by imperfect information such as personal confusion, mental conflict in process of matching.

### SUMMARY OF THE INVENTION

Accordingly, the present invention is conceived to solve the aforementioned problems in the prior art. An object of the present invention is to provide an emotional matching system and a matching method for linking ideal mates, in which optical ideal mates can be found through an emotion-based approach using brainwave changes.

To achieve these goals, an emotional matching system for linking ideal mates of the present invention comprises: a photo input unit which scans photos of male members and female members, and converts the photos into image data; a member photo database which stores the image data of the members' photos; an image output unit which is provided with the image data from the member photo database, and displays the photos of the members of the opposite sex one by one, so that each member can view the photos; a brainwave measurement unit which measures the brainwaves of the members relative to each photo of the opposite sex when the member photos of the opposite sex are displayed on the image output unit; a measured brainwave database which forms, as data, the brainwaves that were measured in the brainwave measurement unit, and stores the data by sorting the data according to each member; a brainwave analysis unit which analyzes and scores changes of the brainwaves for the respective photos of the opposite sex according to each member; a matching unit which selects a couple to arrange a meeting if the mutual scores between the members of the opposite sex are at least a certain level; and a matching information providing unit which provides basic information about the corresponding other member to the members that are selected by the matching unit as a couple to arrange a meeting. Here, in the matching unit, conditions for selecting a couple to arrange a meeting features that the individual scores for the members of the opposite sex are at least a certain level, and combined score between the members of the opposite sex is above the reference.

Also, the brainwave analysis unit, to analyze and score changes of the brainwaves of the members, comprises a reference brainwave database storing data on a brainwave in a comfortable position as a reference brainwave, and if measured brainwave changes comparing of the reference brainwave become or are closer to β waves having 13 Hz˜50 Hz frequency bandwidth, the higher marks will be given.

Also, the invention further comprises a music database which stores music files of different genre like ballad, R&B, rock, hip hop, indie, folk, jazz, new age, and a music output unit which plays music, one for each genre, so that each member can hear the music; and the brainwave measurement unit measures brainwaves of each member changed by the acoustic stimulation relative to the music of difference genre, the brainwave analysis unit analyzes changes of the brainwaves for the acoustic stimulation and classifies tendencies toward music according to each member, and the matching unit considers the tendencies toward music in selecting a couple to arrange a meeting.

Also, the invention further comprises a movie database which stores movie preview files of different genre like action, SF, chivalry, humor/comedies, melo/drama, horror, thriller; and the image output unit which is provided with movie previews from the movie database, and displays movie previews, one for each genre, so that each member can see the movie previews, the brainwave measurement unit measures brainwaves of each member changed by the movie of different genre, the brainwave analysis unit analyzes changes of the brainwaves for the movie of different genre, and classifies tendencies toward movie according to each member, and the matching unit considers the tendencies toward movie in selecting a couple to arrange the meeting.

Also, the invention further comprises a fragrance spray unit which classifies and stores food fragrance of different sort like kimchi stew, chaomamian, fish, sirloin steak, pizza, representative of Korean food, Chinese food, Japanese food, Western food, fast food respectively, and sprays food fragrance, one for each sort, so that each member can smell food fragrance by request; and the brainwave measurement unit measures the brainwaves of each member changed by the olfactory sense stimulation relative to the food fragrance of different sort, the brainwave analysis unit analyzes changes of the brainwaves for the olfactory sense stimulation, and classifies tendencies toward food according to each member, and the matching unit considers the tendencies toward food in selecting a couple to arrange the meeting.

The emotional matching system of the present invention comprises the steps of displaying stored photos of the members of the opposite sex one by one; measuring brainwaves of each member relative to displayed photos of the opposite sex; forming, as data, the brainwaves that were measured for each photo, and storing the data by sorting the data according to each member; analyzing and scoring changes of the brainwaves for the respective photos of the opposite sex according to each member; selecting a couple to arrange a meeting if the mutual scores between the members of the opposite sex are at least a certain level; and providing basic information about the corresponding other member to the members that are selected by the matching unite as a couple to arrange a meeting.

Here, conditions for selecting a couple to arrange the meeting features that the individual scores for the members of the opposite sex are at least a certain level, and combined score between the members of the opposite sex is above the reference.

Also, if measured brainwave changes, comparing of the brainwaves of each member in a comfortable position, become or are closer to β waves having 13 Hz˜50 Hz frequency bandwidth, the higher marks will be given.

Also, the invention features the steps of playing music of different genre like ballad, R&B, rock, hip hop, indie, folk, jazz, new age; measuring the brainwaves of each member changed by the audiogenic stimulation relative to the music of different genre; analyzing changes of the brainwaves for the audiogenic stimulation, and classifying tendencies toward music according to each member; considering the tendencies toward music in selecting a couple to arrange the meeting.

Also, the invention features the steps of showing previews of different genre like action, SF, chivalry, humor/comedies, melo/drama, horror, thriller; measuring brainwaves of each member changed by the movie of different genre; analyzing changes of the brainwaves for the movie of different genre, and classifying tendencies toward movie according to each member; considering the tendencies toward movie in selecting a couple to arrange the meeting.

Also, the invention features the steps of providing food fragrance of different sort like kimchi stew, chaomamian, fish, sirloin steak, pizza, representative of Korean food, Chinese food, Japanese food, Western food, fast food respectively; measuring brainwaves of each member changed by the olfactory sense stimulation relative to the food fragrance of different sort; analyzing changes of the brainwaves for the olfactory sense stimulation, and classifying tendencies toward food according to each member; considering the tendencies toward food in selecting a couple to arrange the meeting.

An emotional matching system and a matching method of the present invention enables optimal ideal mates to be found through an emotion-based approach using brainwave changes.

Also, the present invention can lead to a desirable couple based on the level of attraction to the appearance of the other member and using tendencies to toward music, movies and food as additional grounds.

### BRIEF DESCRIPTION OF THE DRAWINGS

FIG. 1 is the entire block diagram illustrating a constitution of an emotional matching system of the present invention.

FIG. 2 is a block diagram illustrating a brainwave analysis unit according to the present invention.

FIG. 3 is a reference drawing illustrating theoretical background for a brainwave measurement unit to analyze and score changes of the brainwaves.

FIGS. 4-8 are reference drawings illustrating a method of selecting members to arrange a meeting by a matching unit.

FIG. 9 is a network block diagram providing information to the selected members to arrange a meeting.

FIG. 10 is a block diagram illustrating each constitutional step of an emotional matching method of the present invention.

FIG. 11 is a block diagram showing a detailed step of outputting music of different genre.

FIG. 12 is a block diagram showing a detailed step of displaying movie of different genre.

FIG. 13 is a block diagram showing a detailed step of supplying food fragrance of different sort.

### DESCRIPTION OF THE PREFERRED EMBODIMENT

Hereinafter, preferred embodiments according to the present invention will be described in detail with reference to the accompanying drawing.

An emotional matching system and a matching method of the present invention, rather diffidently to date, enables optical ideal mates to be found through an emotion-based scientific approach using brainwave changes. Especially, the present invention can lead to a desirable couple based on the level of attraction to the appearance of the other member and using tendencies to toward music, movies and food as additional grounds.

Hereby, an emotional matching system and a matching method of the present invention breaks from the conventional obsolete way, and finds and matches optical ideal mates of being able to sharing sensibility.

Hereinafter, constitution of an emotional matching system of the present invention will be described in detail.

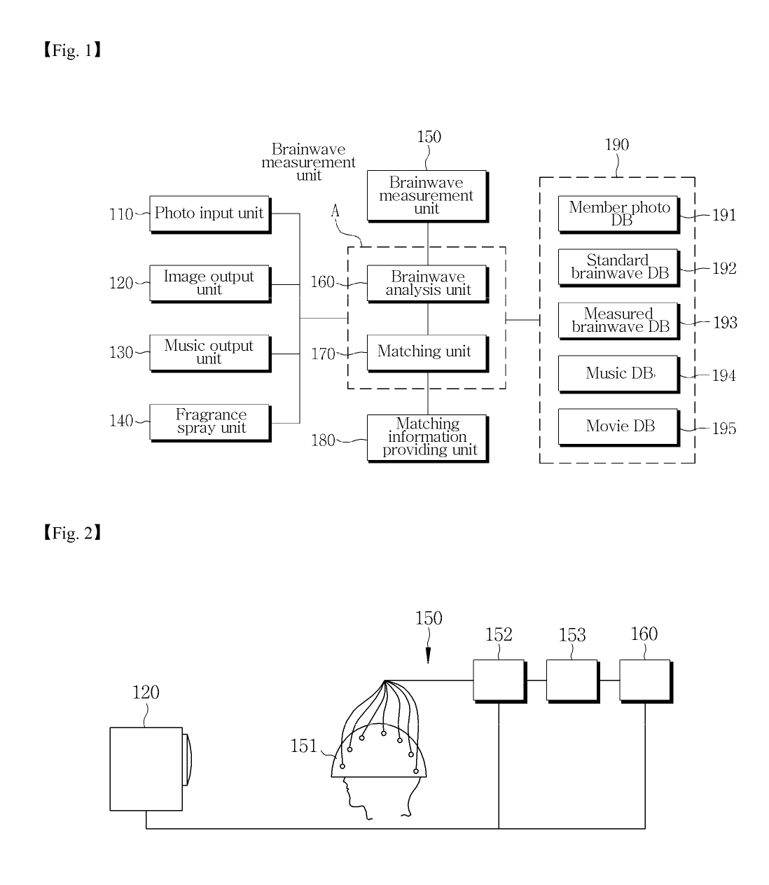

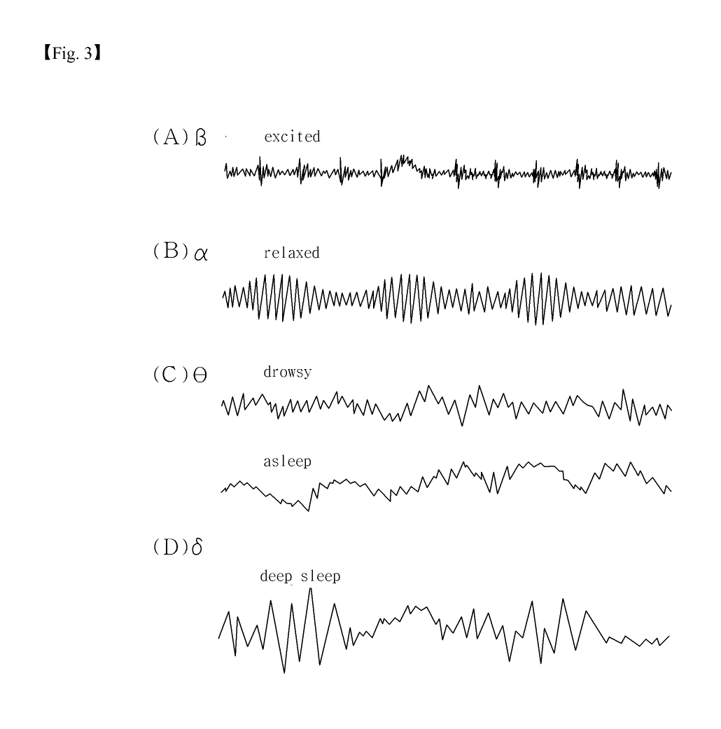

FIG. 1 is the entire block diagram illustrating a constitution of an emotional matching system of the present invention, and FIG. 2 is a block diagram illustrating a brainwave analysis unit according to the present invention.

As shown, an emotional matching system of the present invention focuses a brainwave analysis unit (160) and a matching unit(170) of a controller(A) leading to a desirable couple, and comprises a photo input unit(110), an image output unit(120), a music output unit(130), a fragrance spray unit(140), a brainwave measurement unit(150), a matching information providing unit(180), a database unit(190). This constitution of the present invention will be described below based on each element.

First, the photo input unit(110) scans photos of male members and female members, and converts the photos into image data. It is sufficient for the photo input unit(110) to comprise a common use scanner. A controller(A), comprising a brainwave analysis unit(160) and a matching unit(170), stores the image data from the photo input unit(110) in a member photo database(191) of a database unit(190).

The image output unit(120) is provided with the image data from the member photo database(191), and displays the photos of the members of the opposite sex one by one. It is sufficient for the image output unit(120) to comprise a common use computer monitor. The controller(A) actually plays image data, and the image output unit(120) outputs played image data.

When the image output unit(120) displays the photos of the members of the opposite sex, the brainwave analysis unit(160) and the matching unit(170) analyze changes of the brainwaves of each member for the respective photos of the opposite sex, and select a couple to arrange a meeting based on the same.

Also, the image output unit(120) is provided with movie preview files from the movie database(195), and displays movie previews, one for each genre. At this point, the controller(A) actually plays movie previews, and the image output unit(120) outputs images of the played movie previews.

When the image output unit(120) displays movie previews of different genre, the brainwave analysis unit and the matching unit(170) analyze changes of the brainwaves relative to the movie of different genre, classify tendencies toward movie according to each member, and they may be used as additional grounds to select a couple to arrange a meeting.

The music output unit(130) is provided with music files from the music database(194), and plays music, one for each genre. It is sufficient for the music output unit(130) to be connected to the controller(A) and to comprise a common use computer active speaker. Yet, the music output unit preferably comprises DAC, HiFi amp and passive speaker for better sound quality. The music output unit(130) plays music, one for each genre: ballad, R&B, rock, hip hop, indie, folk, jazz, new age from the music database(194).

When the music output unit(130) plays music of different genre, the brainwave analysis unit and the matching unit(170) analyze changes of the brainwaves relative to the music of different genre, classify tendencies toward music according to each member, and they may be used as additional grounds to select a couple to arrange a meeting.

The fragrance spray unit(140) sprays fragrance, one for each sort. It is sufficient for the fragrance spray unit(140) to be connected to the controller(A), and to comprise a perfume diffuser commonly used in the market. The perfume diffuser itself comprises a plurality of storing chambers to analyze and store fragrances ike kimchi stew, chaomamian, fish, sirloin steak, pizza. Thereby, the fragrance spray unit(140) sprays fragrances of kimchi stew, chaomamian, fish, sirloin steak, pizza, one for each sort. Here, the fragrances of kimchi stew, chaomamian, fish, sirloin steak, pizza are representative of Korean food, Chinese food, Japanese food, Western food, fast food respectively.

When the fragrance spray unit(140) sprays food fragrance of different sort, the brainwave analysis unit and the matching unit(170) analyze changes of the brainwaves relative to food fragrance, classify tendencies toward food according to each member, and they may be used as additional grounds to select a couple to arrange a meeting.

A brainwave measurement unit(150) measures the brainwaves of the members relative to each photo of the opposite sex when the member photos of the opposite sex are displayed on the image output unit(120).

Also, the brainwave measurement unit(150) measures the brainwaves of the members relative to the movie of different genre when movie previews of different genre are displayed on the image output unit(120).

Also, the brainwave measurement unit(150) measures the brainwaves of the members changed by the audiogenic stimulation when music of different genre is played on the music output unit(130).

Also, the brainwave measurement unit(150) measures the brainwaves of the members changed by the olfactory sense stimulation relative to food fragrance of different sort when food fragrances of different sort are sprayed from the fragrance spray unit(140).

As shown in FIG. 2, the brainwave measurement unit(150) measuring changes of the brainwaves of the members in a variety of situations as above comprises: a brainwave sensor(151) directly contacting the head of members, sensing and outputting the brainwaves of the members by converting the brainwaves into electrical brainwave signals; an amplifier(152) amplifying and outputting the brainwave signals from the brainwave sensor(151); an A/D converter(153) outputting the brainwave signals by converting analogue brainwave signals into digital brainwave signals. Here, a brainwave sensor(151), an amplifier(152), a A/D converter(153) of the brainwave measurement unit(150) are easy to get on the market, and have already opened to the public. And so a detailed description thereof will be omitted.

The brainwave analysis unit(160) can judge the level of attraction to the appearance of the other member by analyzing and scoring changes of the brainwaves for the respective photos of the opposite sex according to each member. Based on this, the matching unit(170) select a couple to arrange a meeting. Here, where X is a figure which is ranked according to variation of brainwave changes for the opposite sex of a total membership and expressed as percentages, the score can be calculated as follows:

score=(100−X)

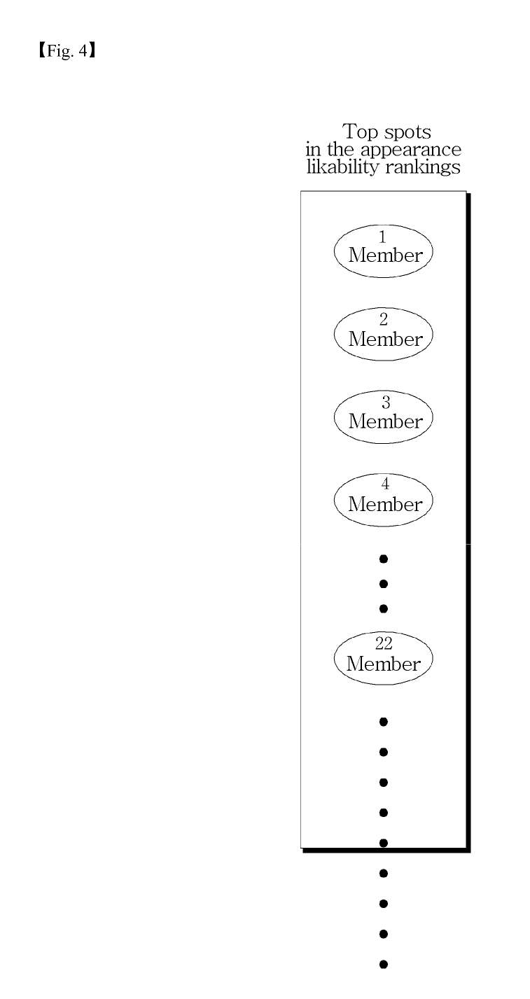

Also, the brainwave analysis unit(160) provides additional supporting grounds for the matching unit(170) to select a couple to arrange a meeting by analyzing changes of the brainwaves relative to the movies of different genre and classifying tendencies toward movies according to each member. Also, the brainwave analysis unit(160) provides additional supporting grounds for the matching unit(170) to select a couple to arrange a meeting by analyzing changes of the brainwaves relative to the movies of different genre and classifying tendencies toward movies according to each member. Also, the brainwave analysis unit(160) provides additional supporting grounds for the matching unit(170) to select a couple to arrange a meeting by analyzing changes of the brainwaves for the audiogenic stimulation and classifying tendencies toward music according to each member. Accompanying FIG. 3 shows theoretical background of the brainwave analysis unit(160) in analyzing and scoring changes of the brainwaves. As shown in FIG. 3, if feels comfortable, one has a wave for 8 to 13Hz frequency bandwidth, a relatively low frequency bandwidth, like (B). Yet, if excited, one has 0 wave for 13 to 50 Hz, a relatively higher frequency bandwidth than α, like (C).

Accordingly, the present invention, for analyzing and scoring brainwave changes of each member, stores at a database unit(190) the brainwave of each member in a comfortable position(α wave) as a reference brainwave. Hereafter, the present invention, based on the reference brainwave, measures changes of the brainwaves as situations like when showing photos of the opposite sex, playing music of different genre, displaying movies of different genre, and spraying food fragrance of different sort. And then, giving higher scores as the brainwaves of each member closes to the brainwave in situations which feel exciting(β wave).

Below table 1 arranges frequency bandwidth by considering brainwave condition. If changed brainwave condition of each member in each situation belongs or close to 13 to 50 Hz, considers as exciting condition and the higher scores may be given. In the case that brainwaves of a target member belongs or close to 13 to 50 Hz, the higher the frequency, the higher the scores.

TABLE 1

| | Frequency | |
|---|---|---|
| Classification | bandwidth (Hz) | Characteristic |
| delta(δ) | 0-3.5 | — |
| theta(θ) | 3.5-8 | not occurring frequently |
| alpha(α) | 8-13 | very rhythmical |
| beta(β) | 13-50 | capriciousness |

The matching unit(170) plays a role in selecting a couple to arrange a meeting if the mutual scores between the members of the opposite sex are at least a certain level. Here, conditions for a selected couple by a matching unit(170) are that the individual scores for the members of the opposite sex are at least a certain level, and combined score between the members of the opposite sex is above the reference. For example, ‘the individual scores for the members of the opposite sex are at least a certain level’, one of the above conditions, means that the mutual brainwave change figures of the members selected as a couple relative to the members of the opposite sex needs to be placed among the top 30% of the entire membership, and the mutual scores on the level of attraction to the appearance need to be at least 70, and combined score between the members of the opposite sex needs to be above 160, on average in the top 20%. The conditions of the individual scores and the combined score is only an instance among many, and it can be adjusted. That is, if there is a plurality of member data files that arrange the meeting, it can be conducted under more stringent conditions. If there is a small member data files that arrange the meeting, conditions can be loosened up.

FIGS. 4-8 are reference drawings illustrating a method of selecting members to arrange a meeting by a matching unit.

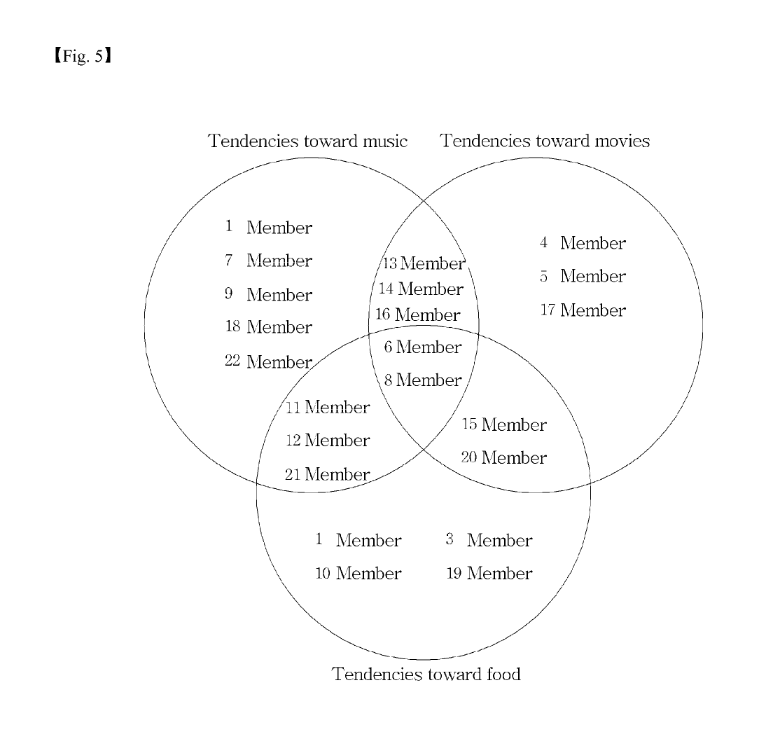

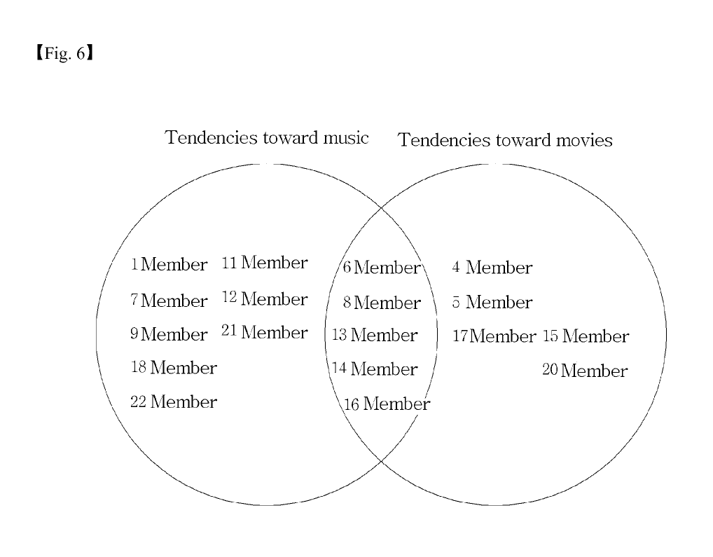

The matching unit(170), as shown in FIG. 4, can select 22 members of the opposite sex that takes top spots in the attraction rankings to the appearance of the other member. Furthermore, as shown in FIG. 5, two members of the opposite sex from the above 22 members, having the same tastes in music, movies and food, can be selected to arrange a meeting.

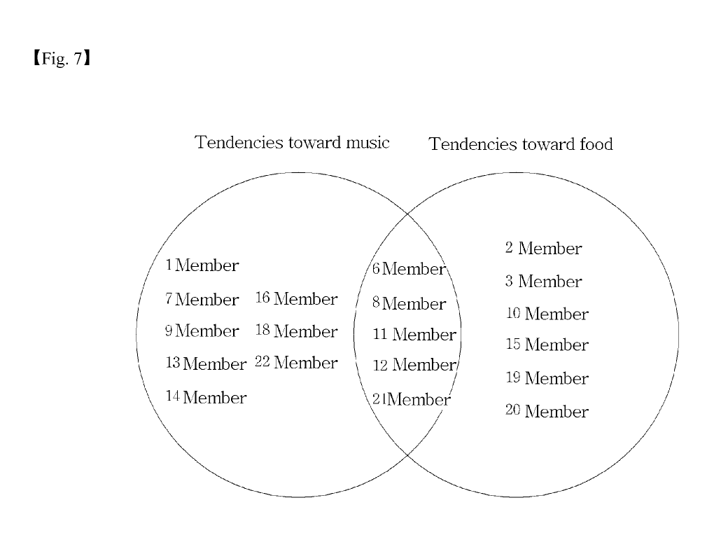

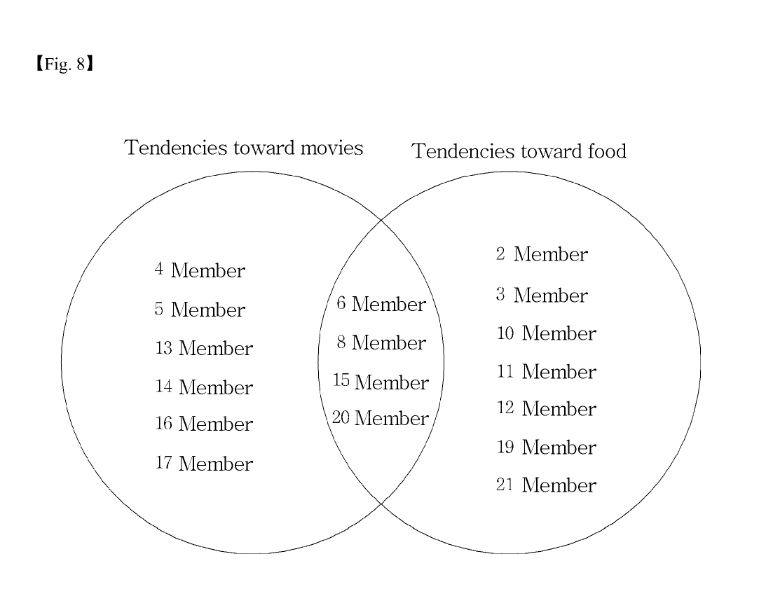

The matching unit(170), followed by the above selected members, can select the members from the above 22 members of the opponent sex, having the same tastes in any two of music, movies and food. FIG. 6 shows that 5 members have the same tastes with the target member in music and movies. FIG. 7 shows that 5 members have the same tastes with the target member in music and food. FIG. 8 shows that 4 members have the same tastes with the target member in movies and food.

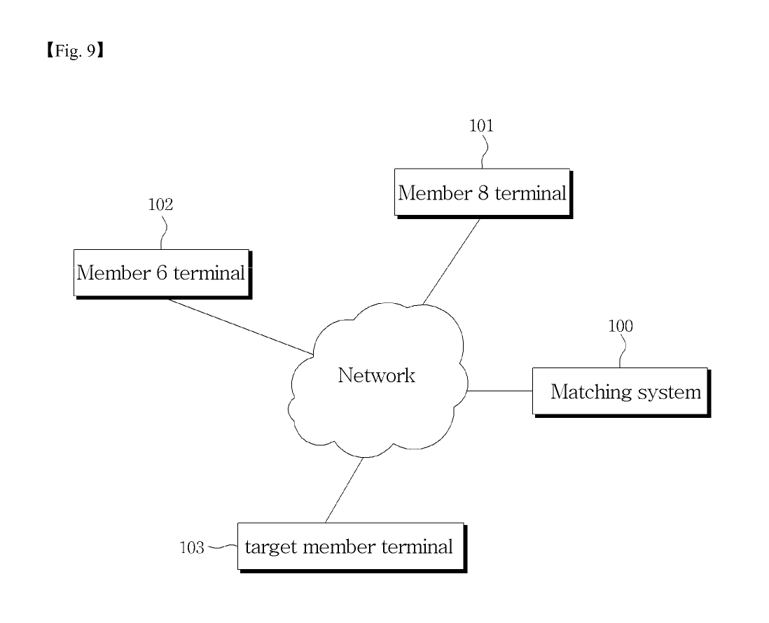

The matching information providing unit(180), as shown in FIG. 9, provides basic information about the corresponding other member to the members that are selected by a matching unit(170) as a couple to arrange the meeting. It is sufficient for the matching information providing unit(180) to be connected to the controller(A), and to comprise such as various interface cards commonly used in the market. It can be adjusted as various types of things considering terminals(101,102,103) of a target member and selected members. For example, network interface card providing information through an internet is sufficient if limit member terminals(101,102,103) to a personal computer or a smart phone. But additional device needs to be introduced if member terminals(101,102,103) are cellular phone and mobile telecommunication media.

The databased unit(190) comprises a member photo DB(191), a standard brainwave DB(192), a measured brainwave DB(193), a music DB(194) and a movie DB (195).

The member photo DB(191) scans photos of male members and female members, and stores the image data.

The standard brainwave DB(192) forms the brainwaves, which are measured in the brainwave measurement unit(150) when each member feels comfortable, as data, and stores the data by sorting the data according to each member. The measured brainwave DB(193) forms, as data, the brainwaves that were measured in the brainwave measurement unit(150), and stores the data by sorting the data according to each member.

The music DB(194) stores music of different genre like ballad, R&B, rock, hip hop, indie, folk, jazz, new age, and provides storing music files for the music output unit(130) to play music.

The movie DB(194) stores movie previews of different genre like action, SF, chivalry, humor/comedies, melo/drama, horror, thriller, and provides storing movie previews for the movie output unit(130) to display movie previews.

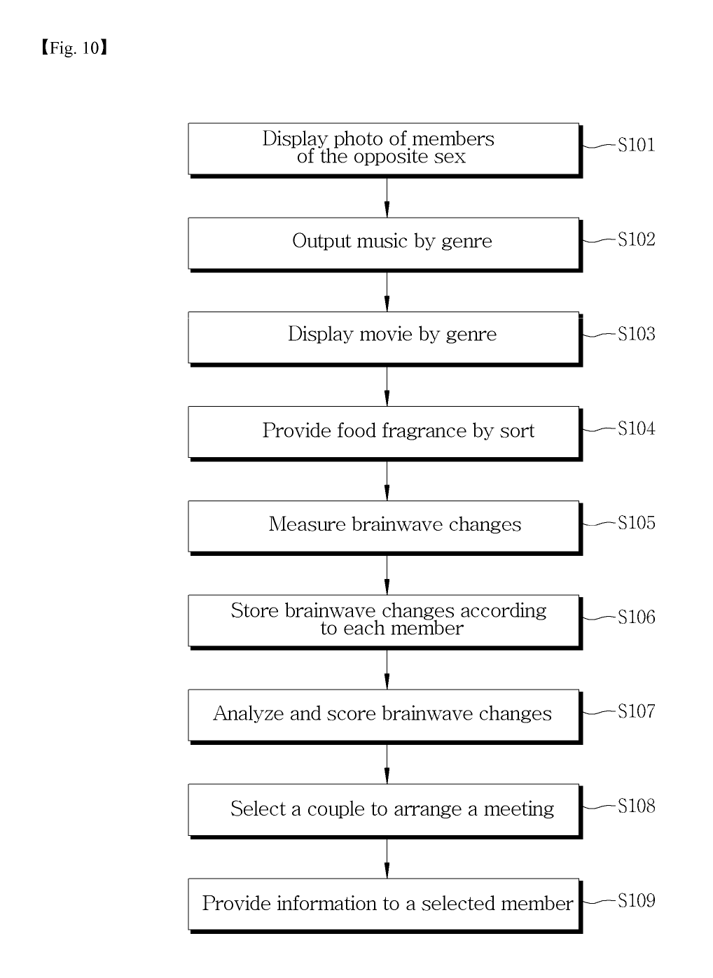

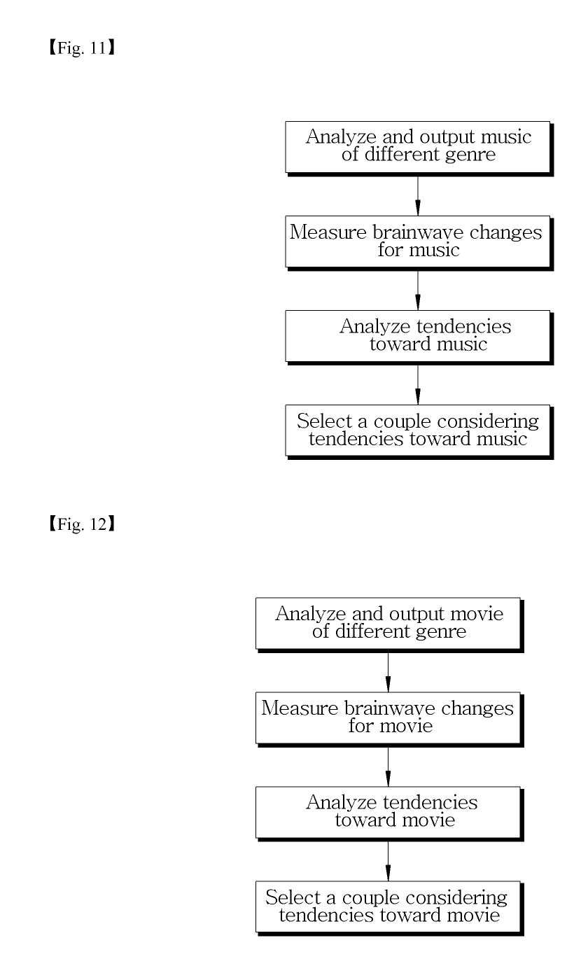

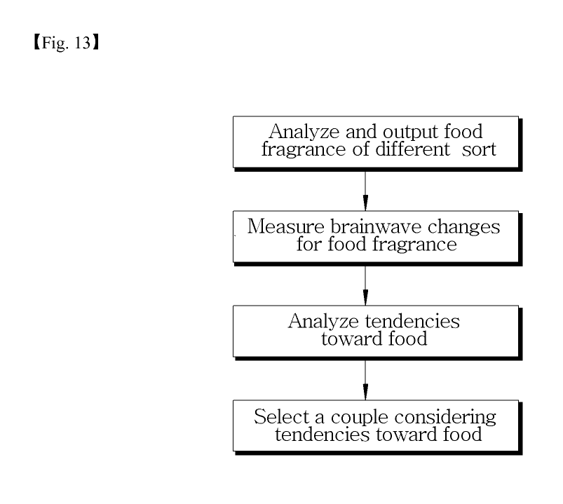

Explanation for the matching method using the aforementioned emotional matching system of the present invention will be continued. FIG. 10 is a block diagram illustrating each constitutional step of an emotional matching method of the present invention, FIGS. 11 to 13 are block diagrams showing detailed steps of outputting music of different genre, displaying movies of different genre and providing food fragrance of different sort.

Before carrying on an emotional matching method of the present invention, placing a brainwave sensor(151) of a brainwave measurement unit(150) on the head of a target member looking for an ideal mate, and making all the components of matching system like a image output unit(120), a music output unit(130), a fragrance spray unit(140), a brainwave measurement unit(150), a brainwave analysis unit(160), a matching unit(170), a database unit(190), a matching information providing unit(180) in its operationally ready state.

First, as shown in FIG. 10, the step of displaying photos of the members of the opponent sex to a target member(S101) is proceeded.

In this step(S101), an image output unit(120) displays photo-based image data from a member photo DB(191), and a target member can see photos of the members of the opponent sex one by one. At this point, brainwave of a target member is rapidly changed when a photo of the opponent sex with high level of attraction to the appearance is displayed.

After this, the step of a measuring brainwave changes(S105) is proceeded(the step of outputting music of different genre(S102), the step of displaying movie of different genre(S103), the step of providing food fragrance of different sort(S104) are additional steps, and will be explained hereafter).

In this step(S105), a brainwave measurement unit(150) measures changes of the brainwaves of a target member.

After this, the step of storing changes of the brainwaves according to each member(S106). In this step(S106), a brainwave analysis unit(160) forms, as data, the measured brainwaves of a target member for photos of each member of the opponent sex, and stores the data. After this, the step of analyzing and scoring brainwave changes (S 107) is proceeded.

In this step(S107), a brainwave analysis unit(160) within a controller(A) analyze and score changes of the brainwaves of a target member for the respective photos of the opposite sex. Here, a ranking of scores from the brainwave analysis unit(160) among a total membership is decided, and the scores are converted into a percentage. When the above figure is X, the score is calculated by a formula Score=100−X. For example, if brainwave change figure of a target member for a particular member of the opponent sex is in the top 25%, the calculated score is 75 from 100−25.

After aforementioned step of analyzing and scoring changes of the brainwaves(S107), a step of selecting a couple to arrange a meeting(S108) is proceeded. In this step(S108), a matching unit(170) within a controller(A) digs out a member of the opponent sex, and selects a couple to arrange the meeting if the mutual scores between the members of the opposite sex are at least a certain level. Here, conditions for a selected couple by the matching unit(170) are that the individual scores for the members of the opposite sex are at least a certain level, and combined score between the members of the opposite sex is above the reference. For example, the individual scores for the members of the opposite sex need to be in the top 30% and at least 70; and combined score between the members of the opposite sex needs to be above 160, on average in the top 20%.

After selecting a couple to arrange a meeting, a step of providing information to a selected member(S109) is proceeded.

In this step(S109), a matching information providing unit provides a message to decide a couple to arrange a meeting, and basic information about the corresponding other member. Hereby, basic steps for an emotional matching method of the present invention are completed, but additional steps of outputting music of different genre(S102), displaying movie of different genre(S103) and providing good fragrance of different sort(S104) can be proceeded.

The outputting music of different genre(S102) comprises a detailed steps that a music output unit(130) plays music by classifying the music of different genre like ballad, R&B, rock, hip hop, indie, folk, jazz, new age; a brainwave measurement unit(150) measures changes of the brainwaves of a target member changed by the audiogenic stimulation relative to the music of different genre; the brainwave anlaytic unit(160) analyzes changes of the brainwaves of a target member for the audiogenic stimulation and classifies tendencies toward music; the matching unit(170) selects, among members having the same tastes in music, a couple to arrange a meeting considering the tendencies toward music.

The displaying movie by genre(S103) comprises a detailed steps that an image output unit(120) displays movie previews of different genre like action, SF, chivalry, humor/comedies, melo/drama, horror, thriller; a brainwave measurement unit(150) measures changes of the brainwaves of a target member relative to the movie of different genre; the brainwave anlaytic unit(160) analyzes changes of the brainwaves of a target member relative to the movie of different genre, and classifies tendencies toward movie; and the matching unit(170) selects, among members having the same tastes in movie, a couple to arrange a meeting considering the tendencies toward movie.

The displaying movie of different genre(S104) comprises a detailed steps that a fragrance spray unit(140) provides food fragrance of different sort like kimchi stew, chaomamian, fish, sirloin steak, pizza; a brainwave measurement unit(150) measures the brainwaves of a target member changed by the olfactory sense stimulation relative to food fragrance of different sort; the brainwave analysis unit(160) analyzes changes of the brainwaves of a target member for the olfactory sense stimulation and classifies tendencies toward food; the matching unit(170) selects, among members having the same tastes in food, a couple to arrange a meeting considering the tendencies toward food.

If additional steps of outputting music of different genre(S102), displaying movie of different genre(S103) and providing food fragrance of different sort(S104) are proceeded, a target member can meet an optical ideal mate having the same tastes in music, movie and food, add to attraction to the appearance.

Even though the above explained the preferred embodiments of the present invention, it will be understood that one having ordinary skill in the art can make various modifications and changes thereto within the scope of the present invention defined by the claims.

What is claimed is:

1. An emotional matching system for liking ideal mates comprising:
a photo input unit scanning photos of male members and female members, and converting the photos into image data;
a member photo database storing the image data of the members' photos;
an image output unit, which is provided with the image data from the member photo database, displaying the photos of the members of the opposite sex one by one;
a brainwave measurement unit measuring the brainwaves of the members relative to each photo of the opposite sex when the member photos of the opposite sex are displayed on the image output unit;
a measured brainwave database forming, as data, the brainwaves that were measured in the brainwave measurement unit, and storing the data by sorting the data according to each member;
a brainwave analysis unit analyzing and scoring changes of the brainwaves for the respective photos of the opposite sex according to each member;
a matching unit selecting a couple to arrange a meeting if the mutual scores between the members of the opposite sex are at least a certain level;
a matching information providing unit providing basic information about the corresponding other member to the members that are selected by the matching unit as a couple to arrange a meeting.

2. The emotional matching system for liking ideal mates as claimed in claim 1, wherein conditions for selecting a couple by the matching unit are that the individual scores for the members of the opposite sex are at least a certain level, and combined score between the members of the opposite sex is above the reference.

3. The emotional matching system for liking ideal mates as claimed in claim 1, wherein the brainwave analysis unit, to analyze and score changes of the brainwaves of the members, comprises a reference brainwave database storing data on a brainwave in a comfortable position as a reference brainwave, and if measured brainwave changes comparing of the reference brainwave become or are closer to β waves having 13 Hz˜50 Hz frequency bandwidth, the higher marks will be given.

4. The emotional matching system for liking ideal mates as claimed in claim 1, wherein the present invention further comprises a music database storing music files of different genre like ballad, R&B, rock, hip hop, indie, folk, jazz, new age, and a music output unit, which is provided with music files from the music database, outputting music, one for each genre, so that each member can hear the music; and the brainwave measurement unit measuring the brainwaves of the members changed by audiogenic stimulation relative to the music of different genre; the brainwave analysis unit analyzing changes of the brainwaves for the acoustic stimulation and classifying tendencies toward music according to each member; and the matching unit considering the tendencies toward music in selecting a couple to arrange the meeting.

5. The emotional matching system for liking ideal mates as claimed in claim 1, wherein the present invention further comprises a movie database storing movie preview files of different genre like action, SF, chivalry, humor/comedies, melo/drama, horror, thriller; and the image output unit, which is provided with movie previews from the movie database, displaying movie previews, one for each genre, so that each member can see the movie; the brainwave measurement unit measuring the brainwaves of the members changed by the movie of different genre; the brainwave analysis unit analyzing changes of the brainwaves relative to the movie of different genre, and classifying tendencies toward movie according to each member; and the matching unit considering the tendencies toward movie in selecting a couple to arrange the meeting.

6. The emotional matching system for liking ideal mates as claimed in claim 1, wherein the present invention further comprises a fragrance spray unit storing food fragrance of different sort like kimchi stew, chaomamian, fish, sirloin steak, pizza, representative of Korean food, Chinese food, Japanese food, Western food, fast food respectively, and spraying food fragrance, one for each sort, so that each member can smell the food fragrance by request; and the brainwave measurement unit measuring the brainwaves of the members changed by olfactory sense stimulation relative to the food fragrance of different sort; the brainwave analysis unit analyzing changes of the brainwaves for the olfactory sense stimulation, and classifying tendencies toward food according to each member; and the matching unit considering the tendencies toward food in selecting a couple to arrange the meeting.

7. An emotional method for linking ideal mates comprising the steps of displaying stored photos of the members of the opposite sex one by one; measuring changes of the brainwaves of each member relative to the displayed photos of the opposite sex; forming, as data, the brainwaves that were measured for each photo, and storing the data by sorting the data according to each member; analyzing and scoring changes of the brainwaves for the respective photos of the opposite sex according to each member; selecting a couple to arrange a meeting if the mutual scores between the members of the opposite sex are at least a certain level; providing basic information about the corresponding other member to the members that are selected by the matching unite as a couple to arrange a meeting.

8. The emotional method for linking ideal mates as claimed in claim 7, wherein conditions for selecting a couple to arrange the meeting are that the individual scores for the members of the opposite sex are at least a certain level, and combined score between the members of the opposite sex is above the reference.

9. The emotional method for linking ideal mates as claimed in claim 7, wherein the scoring by the brainwave analysis features that if the measured brainwave changes, comparing of brainwaves of each member in a comfortable position, become or are closer to 0 waves having 13 Hz˜50 Hz frequency bandwidth, the higher marks will be given.

10. The emotional method for linking ideal mates as claimed in claim 7, wherein the method comprises the steps of playing music of different genre like ballad, R&B, rock, hip hop, indie, folk, jazz, new age; measuring brainwaves of each member changed by audiogenic stimulation relative to the music of different genre; analyzing changes of the brainwaves for the audiogenic stimulation, and classifying tendencies toward music according to each member; considering the tendencies toward music in selecting a couple to arrange the meeting.

11. The emotional method for linking ideal mates as claimed in claim 7, wherein the method comprises the steps of displaying movie previews of different genre like action, SF, chivalry, humor/comedies, melo/drama, horror, thriller; measuring brainwaves of each member changed by the movie of different genre; analyzing changes of the brainwaves relative to the movie of different genre, and classifying tendencies toward movie according to each member; considering the tendencies toward movie in selecting a couple to arrange the meeting.

12. The emotional method for linking ideal mates as claimed in claim 7, wherein the method comprises the steps of providing food fragrance of different sort like kimchi stew, chaomamian, fish, sirloin steak, pizza, representative of Korean food, Chinese food, Japanese food, Western food, fast food respectively; measuring the brainwaves of the members each member changed by olfactory sense stimulation relative to food fragrance of different sort; analyzing changes of the brainwaves for the olfactory sense stimulation, and classifying tendencies toward food according to each member; considering the tendencies toward food in selecting a couple to arrange the meeting.
